(19) United States
(12) Patent Application Publication
(10) Pub. No.: US 2020/0249606 A1
(43) Pub. Date: Aug. 6, 2020

(54) HEATER AND HEATING DEVICE FOR DIVIDING RESISTIVE MEMBERS INTO BLOCKS AND CAUSING RESISTIVE MEMBERS TO GENERATE HEAT BY BLOCK

(71) Applicants: TOSHIBA TEC KABUSHIKI KAISHA, Tokyo (JP); TOSHIBA HOKUTO ELECTRONICS CORPORATION, Hokkaido (JP)

(72) Inventors: Osamu TAKAGI, Tokyo (JP); Kazuhiko KIKUCHI, Kanagawa (JP); Chie Miyauchi, Kanagawa (JP)

(21) Appl. No.: 16/855,300

(22) Filed: Apr. 22, 2020

Related U.S. Application Data
(63) Continuation of application No. 15/624,600, filed on Jun. 15, 2017.

(30) Foreign Application Priority Data
Jun. 20, 2016 (JP) 2016-121403
May 16, 2017 (JP) 2017-097322

(51) Int. Cl. G03G 15/20

(52) U.S. Cl. CPC G03G 15/2053; G03G 15/2021; G03G 15/2042

(57) ABSTRACT

A heater according to an embodiment generally includes resistive members and a first pole-side electrode. The plurality of resistive members are arranged in a first direction. The first pole-side electrode is connected to one ends of the resistive members in a second direction perpendicular to the first direction and configured to divide the plurality of resistive members into a plurality of blocks and to cause the plurality of resistive members to generate heat by the block. The first pole-side electrode includes a first pole-side first electrode provided in a first block including the resistive members arranged successively in the first direction, extending across the one ends of the resistive members in the first block, and connected to the one ends.

### CROSS-REFERENCE TO RELATED APPLICATIONS

This application is a continuation of U.S. patent application Ser. No. 15/624,600, filed on Jun. 15, 2017, which is based upon and claims the benefit of priority from Japanese Patent Application No. 2016-121403, filed on Jun. 20, 2016 and Japanese Patent Application No. 2017-097322, filed on May 16, 2017; the entire contents of each of which are incorporated herein by reference.

### FIELD

Embodiments described herein relate generally to circuit configurations of a heater.

### BACKGROUND

A fixing device in which a heater is pressed against a pressure roller via a belt has been known in the art. The belt and the pressure roller rotate together to send a sheet downstream. The heater heats the sheet via the belt. In this device, the heater includes a plurality of resistive members arranged in a direction perpendicular to a sheet conveyance direction. Electrodes are individually connected to the resistive members. The device selects resistive members to be energized according to the size of a sheet to be heated.

Since the electrodes are individually connected to the resistive members in such a device, the heater disadvantageously has a complicated configuration.

### DESCRIPTION OF THE DRAWINGS

FIG. 1 is a schematic view illustrating an image forming apparatus according to an embodiment;

FIG. 2 is a diagram illustrating a configuration of a fixing device according to the embodiment;

FIG. 3 is a diagram illustrating a configuration example of a heat generating mechanism in the fixing device according to the embodiment;

FIG. 4 is an enlarged view illustrating the heat generating mechanism shown in FIG. 3 with a graph showing an exemplary temperature distribution;

FIG. 5 is a graph showing a temperature distribution when the embodiment is applied on the basis of numeric conditions, and a temperature distribution for comparison;

FIG. 6 is a diagram illustrating a configuration example of another fixing device; and

FIG. 7 is a plan view of a heater.

### DETAILED DESCRIPTION

A heater according to an embodiment generally includes resistive members and a first pole-side electrode. The plurality of resistive members are arranged in a first direction. The first pole-side electrode is connected to one ends of the resistive members in a second direction perpendicular to the first direction and configured to divide the plurality of resistive members into a plurality of blocks and to cause the plurality of resistive members to generate heat by the block. The first pole-side electrode includes a first pole-side first electrode provided in a first block including the resistive members arranged successively in the first direction, extending across the one ends of the resistive members in the first block, and connected to the one ends.

A heating device according to an embodiment generally includes a pressure member, a belt, and a heater. The belt is configured to interpose and convey a sheet together with the pressure member and to heat the sheet and thereby fix an image on the sheet onto the sheet. The heater faces the pressure member via the belt and heats the belt. The heater includes: a plurality of resistive members arranged in a first direction; and a first pole-side electrode connected to one ends of the resistive members in a second direction perpendicular to the first direction and configured to divide the plurality of resistive members into a plurality of blocks and to cause the plurality of resistive members to generate heat by the block. The first pole-side electrode includes a first pole-side first electrode provided in a first block including the resistive members arranged successively in the first direction, extending across the one ends of the resistive members in the first block, and connected to the one ends.

### First Embodiment

An image forming apparatus and a fixing device according to an embodiment will now be described below with reference to the drawings.

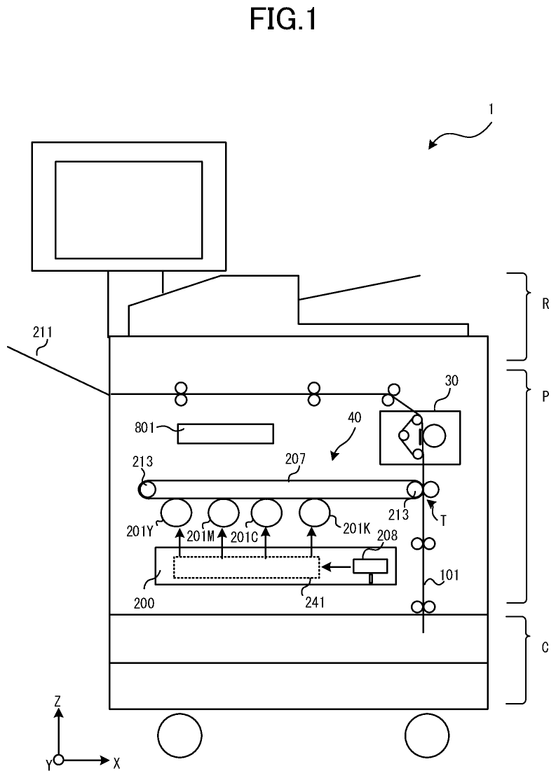

FIG. 1 is a schematic view of the image forming apparatus according to the embodiment. The image forming apparatus 1 includes a reading unit R, an image forming unit P, and a paper cassette unit C. The reading unit R reads a document sheet placed on a platen with a CCD (charge-coupled device) image sensor, for example, so as to convert an optical signal into digital data. The image forming unit P acquires a document image read in the reading unit R or print data from an external personal computer, and forms and fixes a toner image on a sheet.

The image forming unit P includes a laser scanning section 200 and photoconductor drums 201Y, 201M, 201C, and 201K. The laser scanning section 200 includes a polygon mirror 208 and an optical system 241. On the basis of image signals for colors of yellow (Y), magenta (M), cyan (C), and black (K), the laser scanning section 200 irradiates the photoconductor drums 201Y to 201K to provide an image to be formed on the sheet.

The photoconductor drums 201Y to 201K retain respective color toners supplied from a developing device (not shown) according to the above-described irradiated locations. The photoconductor drums 201Y to 201K sequentially transfer the retained toner images onto a transfer belt 207. The transfer belt 207 is an endless belt. The transfer belt 207 conveys the toner image to a transfer location T by the rotary driving of rollers 213.

A conveyance path 101 conveys a sheet stocked in the paper cassette unit C through the transfer location T, a fixing device 30, and an output tray 211 in this order. The sheet stocked in the paper cassette unit C is conveyed to the transfer location T while being guided by the conveyance path 101. The transfer belt 207 then transfers the toner image onto the sheet at the transfer location T.

The sheet having the toner image formed on a surface thereof is conveyed to the fixing device 30 while being guided by the conveyance path 101. The fixing device 30 causes the toner image to penetrate into the sheet and fix therein by the heating and fusion of the toner image. This can prevent the toner image on the sheet from being disturbed by an external force. The conveyance path 101 conveys the sheet having the fixed toner image to the output tray 211 and ejects the sheet from the image forming apparatus 1.

A controller 801 is a unit for controlling devices and mechanisms in the image forming apparatus in a centralized manner. The controller 801 includes, for example, a central processor such as a central processing unit (CPU), and volatile and non-volatile memories. According to an embodiment, a central processor controls the devices and the mechanisms in the image forming apparatus 1 by executing programs stored in memories. Alternatively, the controller 801 may implement part of the functions as a circuit.

A configuration including the sections used for conveying an image (toner image) to be formed to the transfer location T and transferring the image onto the sheet is referred to as a transfer unit 40.

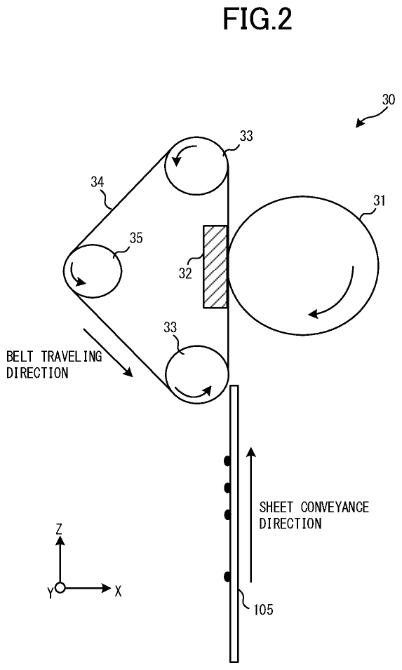

FIG. 2 is a diagram illustrating a configuration example of the fixing device 30 (heating device). The fixing device 30 includes a plate-shaped heater 32, and an endless belt 34 suspended by a plurality of rollers. The fixing device 30 also includes driving rollers 33 for suspending the endless belt 34 and rotary-driving the endless belt 34 in a given direction. The fixing device 30 also includes a tension roller 35 for providing tension as well as suspending the endless belt 34. The fixing device also includes a pressure roller 31 (pressure member) having an elastic layer formed on a surface thereof. A heat generating side of the heater 32 is in contact with an inner surface of the endless belt 34. The heater 32 is pressed against the pressure roller 31. This allows a sheet 105 having a toner image thereon to be interposed, heated, and pressurized at a contact portion (nip portion) formed by the endless belt 34 and the pressure roller 31. In other words, the endless belt 34 interposes and conveys the sheet together with the pressure roller 31, heats the sheet, and thereby fixes the image on the sheet onto the sheet. The heater 32 faces the pressure roller 31 via the endless belt 34, and heats the endless belt 34.

In the heater 32, a heat generating resistive layer (a heat generating resistive member 60 to be described later) is stacked on a ceramic substrate, and a protective layer made of a heat-resistant material is further stacked thereon. The protective layer is provided in order to prevent the ceramic substrate and the heat generating resistive layer from being in contact with the endless belt 34. This can reduce the abrasion of the endless belt 34.

In this embodiment, the ceramic substrate of the heater 32 has a thickness of 1 to 2 mm. The protective layer is made of SiO₂ and has a thickness of 60 to 80 μm. The endless belt 34 includes a base layer (Ni/SUS/PI: a thickness of 60 to 100 μm), an elastic layer (Si rubber: a thickness of 100 to 300 μm), and a release layer (PFA: a thickness of 15 to 50 μm) sequentially provided from the side in contact with the heater 32. The thicknesses and materials of such layers are provided by way of example only.

The endless belt 34 may utilize the rotation of the pressure roller 31 as its source of motive power.

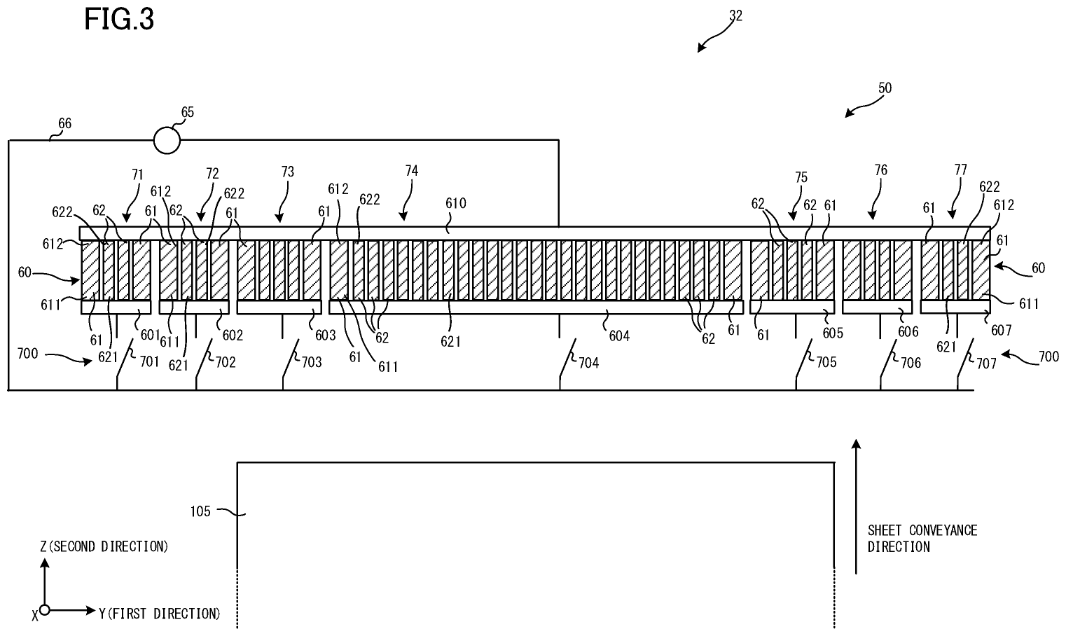

FIG. 3 illustrates a heat generating mechanism 50.

Hereinafter, a direction corresponding to a sheet conveyance direction as well as a shorter-side direction of (the ceramic substrate of) the heater is defined as a Z-axis direction (second direction). A direction corresponding to a sheet width direction as well as a longer-side direction of the heater 32 is defined as a Y-axis direction (first direction). The Y-axis direction is perpendicular to the Z-axis direction. A direction corresponding to a direction toward the pressure roller 31 as well as a vertical direction of the heater 32 is defined as an X-axis direction. The X-axis direction is perpendicular to the Z-axis direction and the Y-axis direction.

The heater 32 includes the heat generating mechanism 50 for causing the heat generation of the heater 32. The heat generating mechanism 50 includes resistive members 61 and 62, a plurality of electrodes 601 to 607, and an electrode 610. The heat generating mechanism 50 also includes a plurality of switching elements 701 to 707, a power source 65, and wiring 66. The plurality of switching elements 701 to 707 are referred to as a switch unit 700.

The resistive members 61 and 62 face a surface of the sheet 105 being conveyed. The plurality of resistive members 61 and 62 are arranged in the Y-axis direction. The Y-axis direction is perpendicular to the sheet conveyance direction. Each of the resistive members 61 and 62 is connected to the electrode 610 (second pole-side electrode) at one end thereof and connected to any one of the electrodes 601 to 607 (first pole-side electrode) at the other end thereof.

The electrode 610 and the electrodes 601 to 607 are each made of an aluminum layer. While the electrode 610, which is one of the electrodes, is integrally formed, the other one of the electrodes is divided into the electrodes 601 to 607 as shown in the figure. Such divisions of the electrodes 601 to 607 are herein referred to as blocks (blocks 71 to 77). In this embodiment, the resistive members 61 are disposed at both ends of each of the blocks 71 to 77, and the resistive members 62 are disposed on the inner side of such a block. A length (width) of the resistive member 61 in the Y-axis direction is set larger than a length (width) of the resistive member 62 in the Y-axis direction. An area of the resistive member 61 is thus larger than an area of the resistive member 62. The reason for this will be described later.

The electrodes 601 to 607 are connected to the switching elements 701 to 707, respectively. By the ON and OFF operations of the switching elements 701 to 707, the resistive members 61 and 62 in the block are energized by the power source 65 to generate heat for each of the blocks 71 to 77.

The positions of the blocks 71 to 77 and the lengths thereof in the Y-axis direction are determined on the basis of the standard sizes of sheets. When the sheet 105 being conveyed has a small size, heat generation in a region where no sheet passes through is essentially unneeded. Therefore, in this embodiment, ON and OFF control is performed for each of the blocks 71 to 77 according to the size of a sheet being conveyed. When an A5-size small sheet is heated, for example, the block 74 is turned ON and the other blocks are turned OFF. In the case of an A4-size sheet, the blocks 73, 74, and 75 are turned ON and the other blocks 71, 72, 76, and 77 are turned OFF, for example. In the case of an A3-size sheet, all of the blocks are turned ON, for example. Such energization control is performed by the ON and OFF operations of the switching elements 701 to 707 in accordance with control made by the controller 801. In this manner, unnecessary heat generation can be prevented from occurring by controlling which block(s) (the resistive members therein) are energized according to the sheet size.

In this embodiment, while energization control for each of the blocks is performed independently, energization control for the resistive members 61 and 62 in each block is performed together.

As mentioned above, the electrodes 601 to 607 (first pole-side electrode) are connected to one of the poles in the power source 65. The electrodes 601 to 607 are connected to one ends 611 and 621 of the resistive members 61 and 62 in the Z-axis direction. The electrodes 601 to 607 divide the plurality of resistive members 61 and 62 into the plurality of blocks 71 to 77. The electrodes 601 to 607 cause the plurality of resistive members 61 and 62 to generate heat by the block.

In this embodiment, the electrodes 601 to 607 are first pole-side first electrodes provided in the blocks 71 to 77 (first blocks) each including the plurality of resistive members 61 and 62 arranged successively in the Y-axis direction. The electrodes 601 to 607, which are the first pole-side first electrodes, extend across the one ends 611 and 621 of the resistive members 61 and 62 in the blocks 71 to 77 (first blocks). The electrodes 601 to 607 connect to the one ends 611 and 621.

The electrode 610, on the other hand, is the second pole-side electrode extending across the other ends 612 and 622 of the resistive members 61 and 62 in the plurality of blocks 71 to 77 (all blocks) arranged successively in the Y-axis direction. The electrode 610, which is the second pole-side electrode, connects to the other ends 612 and 622 as well as to the other one of the poles in the power source 65.

Among the plurality of blocks 71 to 77, a length L10 of the block 74 in the Y-axis direction, which is disposed in a central region in the Y-axis direction, is greater than lengths L20 and L30 of the other blocks 71 to 73 and 75 to 77 in the Y-axis direction. The lengths L20 of the blocks 73 and 75 in the Y-axis direction, which are disposed on the both sides of the block 74, are equal to each other. The lengths L30 of the blocks 72 and 76 in the Y-axis direction, which are disposed on the outer sides of the blocks 73 and 75, are equal to each other and smaller than the lengths L20 of the blocks 73 and 75. The lengths L30 of the blocks 71 and 77 in the Y-axis direction, which are disposed on the outer sides of the blocks 72 and 76, are equal to each other and equal to the lengths L30 of the blocks 72 and 76.

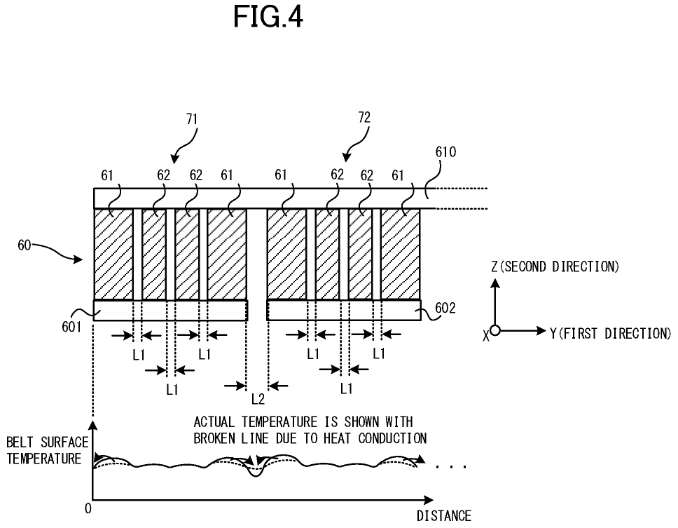

The upper part of FIG. 4 shows an enlarged view illustrating the vicinity of the blocks 71 and 72. The lower part of FIG. 4 provides a graph roughly showing a temperature distribution. The vertical axis of the temperature distribution graph represents a temperature transferred to the endless belt 34. The horizontal axis thereof represents a distance from an end of the heat generating resistive member 60.

As shown in the upper part of FIG. 4 and FIG. 3 described above, the resistive member 61 is longer than the resistive member 62 in the Y-axis direction (width direction). In addition, the resistive members 61 are disposed at the both ends of each block in the Y-axis direction. A gap L1 between the resistive members 62 in each block (or between the resistive members 61 and 62 in each block) is set within 1 mm in this embodiment. A temperature corresponding to the position of such a gap is lower than a temperature corresponding to the position of the resistive member as shown in the lower part of FIG. 4. As the gap L1 becomes larger (longer), this tendency becomes more prominent and thus a temperature difference on the temperature distribution graph becomes larger. By setting the length of the gap L1 within 1 mm as in this embodiment, heating unevenness can be reduced to an acceptable level. Note that the length of the gap L1 may be changed according to the size or material of the resistive member.

In this embodiment, a gap L2 between adjacent ones of the blocks 71 to 77 (between the resistive members 61) is set longer than the gap L1 in the blocks 71 to 77. In other words, the gap L2 between adjacent ones of the blocks 71 to 77 is larger than the gap L1 between the resistive members 61 and 62 in the blocks 71 to 77. This is because a certain distance or more needs to be provided between adjacent ones of the blocks 71 to 77 in order to prevent leakage therebetween. In this embodiment, the length of the gap L2 is set to about 1.5 mm (in the case of 100 V). The length of the gap L2 may also be changed according to the size or material of the resistive member, or the voltage value.

Since the gap L2 has a longer length as described above, a temperature corresponding to the position of the inter-block gap L2 (gap length=L2) is even lower than a temperature corresponding to the position of the in-block gap L1 (gap length=L1) as shown in the lower part of FIG. 4 (shown with the solid line on the temperature distribution graph). In order to reduce such a temperature decrease, the width of the resistive members 61 positioned at the both ends of each of the blocks 71 to 77 is set longer than the width of the resistive member 62, so that the resistive member 61 reliably has an area larger than that of the resistive member 62. Due to such a larger area, temperature in the resistive member 61 becomes higher than temperature in the resistive member 62 (shown with the solid line on the temperature distribution graph). In other words, in the resistive members 61 and 62 in each of the blocks 71 to 77, the amount of heat generation in each of the resistive members 61 positioned at the both ends in the Y-axis direction is greater than the amount of heat generation in each of the other resistive members 62.

While the amount of heat generation in the resistive member 61 is increased as mentioned above, the heat generated in the resistive member 61 transfers from the high-temperature side to the low-temperature side due to heat conduction. In other words, the heat transfers to the position of the inter-block gap L2 (gap length=L2) adjacent to the resistive members 61. Consequently, the temperature in the resistive member 61 is decreased, whereas the temperature in the inter-block gap L2 is increased. The temperature distribution graph shown in the lower part of FIG. 4 shows actual temperature in this embodiment not with the solid line but with a broken line. This can prevent the temperature difference from becoming prominent, thereby maintaining the evenness of heating temperature.

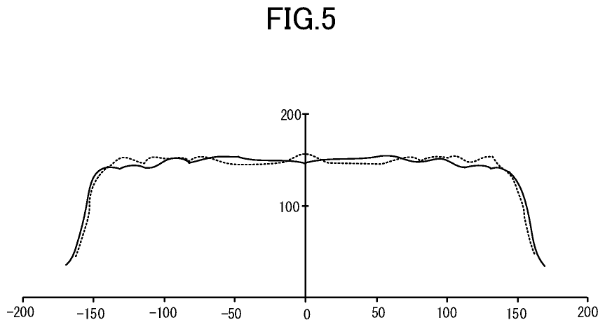

FIG. 5 is a graph showing temperature distributions when the in-block gap L1 is set to 0.1 mm and the inter-block gap L2 is set to 1.5 mm. The broken line shows a temperature distribution when the area of the resistive member 61 disposed at each end in the blocks 71 to 77 is increased by doubling the width thereof. The solid line, on the other hand, shows a temperature distribution when the resistive members 61 and 62 all having the same width (the same area) are employed. The horizontal axis of the graph represents a distance in the Y-axis direction wherein the center of the heater 32 in the Y-axis direction is defined as the reference value zero.

As shown in FIG. 5, in the solid-line temperature distribution, the temperature gradually increases over a range from −150 to −50 on the horizontal axis and reaches a predetermined temperature (about 150° C. in this embodiment) in a central region. The temperature gradually decreases over a range from 50 to 150 on the horizontal axis. In the broken-line temperature distribution, on the other hand, the temperature rapidly increases around a range from −150 to −130 to reach the predetermined temperature, and rapidly decreases around a range from 130 to 150 to reach a low temperature. In other words, this means that the broken-line temperature distribution has an increased range in which the predetermined temperature is achieved. This is because the increased width of the inter-block gap L2 leads to the improved efficiency in heat conduction between adjacent ones of the blocks 71 to 77.

While each of the above-described blocks 71 to includes the plurality of resistive members 61 and 62, each block may include only a single resistive member 61 or 62. In other words, the heat generating resistive member 60 is divided in blocks only, and each of the blocks 71 to 77 has a single body.

An aluminum material may be used as a material of the electrodes.

### Second Embodiment

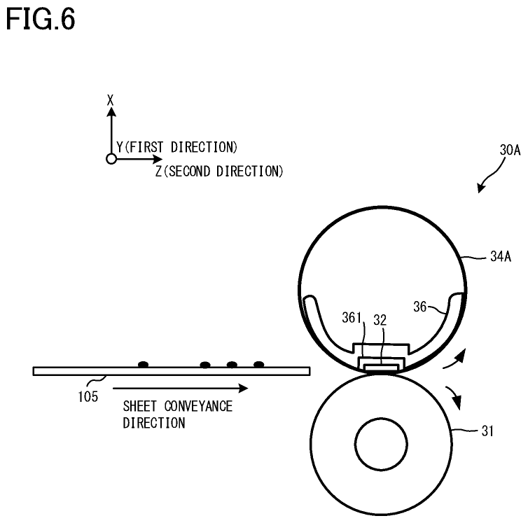

The second embodiment describes an exemplary aspect in which the configuration of the fixing device in the first embodiment is modified. FIG. 6 is a diagram illustrating a configuration example of a fixing device 30A.

A film guide 36 has a semi-cylindrical shape and accommodates a heater 32 in a recess 361 provided on an outer periphery thereof.

A fixing film 34A (belt) is an endless rotating belt. The fixing film 34A is fitted over the outer periphery of the film guide 36. The fixing film 34A is interposed between the film guide 36 and a pressure roller 31 and driven by the rotation of the pressure roller 31.

The above-described heater 32 is in contact with the fixing film 34A to heat the fixing film 34A.

A sheet 105 having a toner image formed thereon is conveyed to a place between the fixing film 34A and the pressure roller 31. The fixing film 34A heats the sheet and thereby fixes the toner image on the sheet onto the sheet.

The aspects of the heater 32 and the heat generating mechanism 50 shown in FIGS. 3 and 4 can be also applied to the fixing device 30A of the second embodiment.

### Third Embodiment

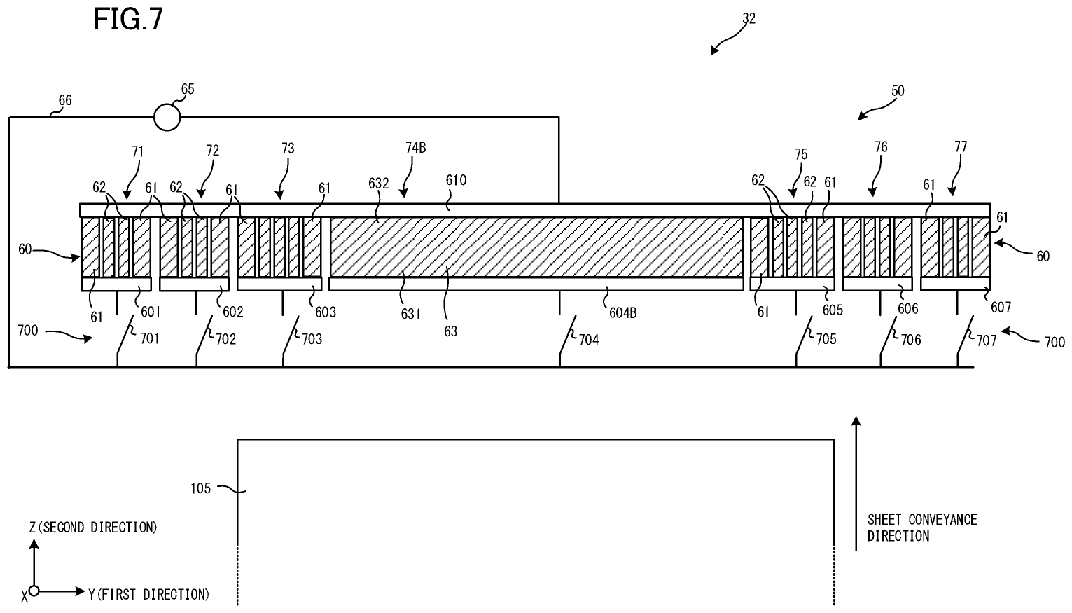

FIG. 7 is a plan view of a heater 32 illustrating a block 74B.

In the first to third embodiments, it is only necessary that at least one of the blocks 71 to 77 is a block (first block) including the plurality of resistive members 61 and 62 arranged successively in the Y-axis direction.

In the third embodiment, the single block 74B includes only a single resistive member 63. Electrodes 601 to 603, 604B, and 605 to 607 connect to one of the poles in a power source 65 and function as a first pole-side electrode that causes a plurality of resistive members 61 to 63 to generate heat by the block. The electrode 604B is provided in the block 74B (second block) having the single resistive member 63. The electrode 604B is a first pole-side second electrode connected to one end 631 of the resistive member 63 in the Z-axis direction. A length of the block 74B (second block) in the Y-axis direction is larger than lengths of the other blocks 71 to 73 and 75 to 77 in the Y-axis direction. Other configurations of the third embodiment are similar to those of the first embodiment.

In the first to third embodiments, the block 74 or 74B that is turned ON when a sheet with the smallest size is heated is disposed in the central region of the blocks 71 to 77 in the Y-axis direction. However, the block 74 or 74B that is turned ON when a sheet with the smallest size is heated may be disposed at an end of the blocks 71 to 77 in the Y-axis direction. In this case, among the plurality of blocks 71 to 77, a length of the block 74 or 74B in the Y-axis direction, which is disposed at the end in the Y-axis direction, may be larger than lengths of the other blocks 71 to 73 and 75 to 77 in the Y-axis direction.

As described above, the embodiments can prevent unnecessary heat generation and can reduce heating unevenness. Moreover, the resistive members 61 and 62 divided into blocks by the electrodes 601 to 607 (first pole-side first electrodes) are energized simultaneously and all together by the block in the embodiments. Thus, the resistive members 61 and 62 in the same one of the blocks 71 to 77 similarly increase their temperatures. Consequently, a temperature difference among these resistive members 61 and 62 is less likely to occur in this embodiment as compared to a configuration in which the resistive members 61 and 62 are energized not by a block but on an individual basis, for example. Therefore, the occurrence of the temperature unevenness in the same one of the blocks 71 to 77 can be reduced.

In the above-described embodiments, the fixing devices 30 and 30A have been described as examples of the heating device. The heating device, however, may perform a decolorization treatment for decolorizing an image on a sheet by heating the sheet. In this case, the image is assumed to be formed with a decolorable colorant, which is decolorized when heated. Alternatively, the heating device may be employed for purposes other than the heat treatment of a sheet. The heating device may be employed for a treatment to uniformly heat and dry a panel, for example.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A heater, comprising:
a plurality of resistive members arranged in a first direction, each resistive member of the plurality extending in a second direction perpendicular to the first direction; and
first pole-side electrodes connected to first ends of the plurality of resistive members in the second direction and to dividing the plurality of resistive members into a plurality of blocks and to permit each of the plurality of blocks to generate heat, a first one of the first pole-side electrodes being provided in a first block of the plurality of blocks, the first block including a first subset of the plurality resistive members arranged successively in the first direction, the first one of the first pole-side electrodes extending across the first ends of the plurality of resistive members in the first block, and connected to the first ends of the plurality of resistive members in the first block, wherein
in each respective block in the plurality of blocks, the width, in the first direction, of each resistive member positioned at an outermost end of the respective block in the first direction is greater than the width, in the first direction, of each other resistive member in the respective block.

2. The heater according to claim 1, wherein in the plurality of resistive members in the first block, an amount of heat generation in each resistive member of the plurality of resistive members disposed at both the outermost ends in the first direction is greater than an amount of heat generation in each of the other resistive members of the plurality of resistive members in the first block.

3. The heater according to claim 1, further comprising:
a second pole-side electrode provided across the plurality of blocks, the second pole-side electrode extending across second ends of the plurality of resistive members opposite the first ends in the second direction, the second pole-side electrode being connected to the second ends of the plurality of resistive members.

4. The heater according to claim 1, wherein a gap between adjacent blocks in the plurality of blocks in the first direction is greater than a gap between adjacent resistive members of the plurality of resistive members within each respective block in the first direction.

5. The heater according to claim 1, wherein
the plurality of blocks includes a second block including only a single resistive member of the plurality of resistive members, and
a second one of the first pole-side electrodes is connected to the first end of the single resistive member of the second block.

6. The heater according to claim 1, wherein a length, in the first direction, of a one block in the plurality of blocks that is disposed in a central region of the plurality blocks along the first direction is greater than lengths, in the first direction, of the other blocks in the plurality of blocks that are disposed outside the central region.

7. The heater according to claim 1, wherein
the plurality of blocks includes a second block disposed in a central region of the plurality of blocks along the first direction and including only a single resistive member of the plurality of resistive members,
a second one of the first pole-side electrodes is connected to the first end of the single resistive member of the second block, and
a length of the second block in the first direction is greater than lengths of the other blocks in the plurality of blocks in the first direction.

8. A heating device, comprising:
a pressure member;
a heater facing the pressure member; and
a belt configured to convey a sheet between the pressure member and the heater to heat the sheet and thereby fix an image onto the sheet, wherein the heater comprises:
a plurality of resistive members arranged in a first direction, each resistive member of the plurality extending in a second direction perpendicular to the first direction; and
first pole-side electrodes connected to first ends of the plurality of resistive members in the second direction and dividing the plurality of resistive members into a plurality of blocks and to permit each of the plurality of blocks to generate heat selectively, a first one of the first pole-side electrodes being provided in a first block of the plurality of blocks, the first block including a first subset of the plurality resistive members arranged successively in the first direction, the first one of the first pole-side electrodes extending across the first ends of the plurality of resistive members in the first block, and connected to the first ends of the plurality of resistive members in the first block, wherein
in each respective block in the plurality of blocks, the width, in the first direction, of each resistive member positioned at an outermost end of the respective block in the first direction is greater than the width, in the first direction, of each other resistive member in the respective block.

9. The heating device according to claim 8, wherein in the plurality of resistive members in the first block, an amount of heat generation in each resistive member of the plurality of resistive members disposed at both the outermost ends in the first direction is greater than an amount of heat generation in each of the other resistive members of the plurality of resistive members in the first block.

10. The heating device according to claim 8, further comprising:
a second pole-side electrode provided across the plurality of blocks, the second pole-side electrode extending across second ends of the plurality of resistive members opposite the first ends in the second direction, the second pole-side electrode being connected to the second ends of the plurality of resistive members.

11. A fixing device, comprising:
a first electrode extending in a first direction;
a plurality of second electrodes spaced from the first electrode in a second direction perpendicular to the first direction and spaced from each other along the first direction
a plurality of heating blocks spaced from each other along the first direction, each heating block having a first end connected the first electrode and a second end connected to a respective one of the plurality of second electrodes, wherein
a first heating block in the plurality of heating blocks is adjacent to a second heating block in the plurality of heating blocks across a gap having a first width in the first direction,
the first heating block comprises a first resistive heating member and a second resistive heating member, each extending in the second direction from the first end of the first heating block to the second end of the first heating block,
the first resistive heating member being on an outermost edge of the first heating block in the first direction, the outermost edge facing the second heating block,
the second resistive heating member being adjacent to the first resistive heating member in the first direction,
the first resistive heating member having a width in the first direction that is greater than a width of the second restive heating member in the first direction, and
a gap between the first and second resistive heating members in the first direction having a second width that is less than the first width.

12. The fixing device according to claim 11, wherein
the first heating block further comprises a third resistive heating member on another outermost edge of the first heating block in the first direction, and
the second resistive heating member is between the first and third resistive heating members in the first direction.

13. The fixing device according to claim 12, wherein the third resistive heating member has the same width in the first direction as the first resistive heating member.

14. The fixing device according to claim 11, wherein
the second heating block comprises a third resistive heating member and a fourth resistive heating member, each extending in the second direction from the first end of the second heating block to the second end of the second heating block,
the third resistive heating member is on an outermost edge of the second heating block in the first direction, the outermost edge facing the first heating block,
the third resistive heating member is adjacent to the fourth resistive heating member in the first direction,
the third resistive heating member has a width in the first direction that is greater than a width in the first direction of the fourth resistive heating member, and
a gap between the third and fourth resistive heating members in the first direction is a third width that is less than the first width.

15. The fixing device according to claim 11, wherein
a third heating block in the plurality of blocks comprises a single resistive heating member extending in the second direction from the first end of the third heating block to the second end of the third heating block, the width of the single resistive heating member in the first direction being equal to the width of the third heating block in the first direction.
